(19) United States
(12) Patent Application Publication
(10) Pub. No.: US 2021/0192571 A1
(43) Pub. Date: Jun. 24, 2021

(54) COBRANDED SEARCH EXPERIENCE FOR PUBLISHING WEBSITES

(71) Applicant: Microsoft Technology Licensing, LLC, Redmond, WA (US)

(72) Inventors: Flint LUU, Seattle, WA (US); Rahul LAL, Redmond, WA (US); Diane Mary Ash SHAMBAUGH, Redmond, WA (US); Hariharan RAGUNATHAN, Bellevue, WA (US); Marcelo Medeiros DE BARROS, Redmond, WA (US); Qianyu LIU, Redmond, WA (US); Benjamin David BRUBAKER, Seattle, WA (US); Shuai HAN, Mercer Island, WA (US)

(21) Appl. No.: 16/722,386

(22) Filed: Dec. 20, 2019

(51) Int. Cl. G06Q 30/02; G06F 16/958; G06F 16/953; G06F 16/2457

(52) U.S. Cl. CPC G06Q 30/0256; G06F 16/24578; G06F 16/953; G06F 16/958

(57) ABSTRACT

A content publisher incorporates a script into a web page. The script consumes an event raised in response a user submitting a query. The script captures the query and related information and sends the captured query and information to a search provider, either directly or through the content publisher. The search provider uses the query and information to identify both the content publisher and branding information associated with the content publisher. An iframe is assembled by the search provider that contains current results from the content publisher as well as web results. The iframe is branded with the content publisher branding information and returned to the user, either directly or through the content publisher. The resultant search experience appears as if it were provided by the content publisher.

### FIELD

This application relates generally to search techniques. More specifically, this application relates to cobranding search for publishing websites.

### BACKGROUND

For any news or content publishing websites, providing a relevant and fresh search experience is important to customer satisfaction when they visit such websites and search for content on the website. However, building a search experience that meets customer's expectations is an expensive and resource intensive endeavor. There are a few open source solutions available like elastic search, but integration and maintenance of such open source solutions can be a daunting and expensive undertaking.

It is within this context that the present embodiments arise.

### BRIEF DESCRIPTION OF DRAWINGS

FIG. 1 illustrates an example architecture diagram according to some aspects of the present disclosure.

FIG. 2 illustrates a conceptual representation of a cobranded search experience according to some aspects of the present disclosure.

FIG. 3 illustrates an example results page according to some aspects of the present disclosure.

FIG. 4 illustrates an example flow diagram for a cobranded search experience according to some aspects of the present disclosure.

FIG. 5 illustrates an example architecture for a cobranded search experience according to some aspects of the present disclosure.

FIG. 6 illustrates an example flow diagram according to some aspects of the present disclosure.

FIG. 7 illustrates a representative architecture for implementing the systems and other aspects disclosed herein or for executing the methods disclosed herein.

### DETAILED DESCRIPTION

The description that follows includes illustrative systems, methods, user interfaces, techniques, instruction sequences, and computing machine program products that exemplify illustrative embodiments. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

### Overview

The following overview is provided to introduce a selection of concepts in a simplified form that are further described below in the Description. This overview is not intended to identify key features or essential features of the claimed subject matter, nor is it intended to be used to limit the scope of the claimed subject matter. Its sole purpose is to present some concepts in a simplified form as a prelude to the more detailed description that is presented later.

Many content publishers, such as news outlets, magazines, and others, rely heavily on their web sites to drive traffic, customer opinion, revenues, and other business metrics. These content publishers often release new content daily, if not hourly. Thus, content publishers amass vast stores of data that are of interest to customers and other visitors to their web sites.

For any news or content publishing websites, providing a relevant and fresh search experience is critical. To ensure better content discovery, engagement, as well as support efforts to monetize each of these domains, the content publisher would need to build search experience for their websites. It is expensive and resource intensive to build and maintain a custom search experience for each of these publishers. There are few open source solutions like elastic search available, but still it would need additional integration and maintenance work to make them work for each of these content websites. In addition to content discovery, each of these domains need to invest on additional work to provide advertising content to ensure they can monetize for business continuity.

It can be possible to use a customized search experience by enlisting the help of a major search provider such as Google®, however, to date such customized solutions draw the user away from the content publisher's website into the websites offered by the search provider. More jarring is that results from the search provider are easily recognizable as coming from the search provider and not from the content publisher. Once enters a query and results are provided by the search provider, that visitor has effectively left the content publisher's web site and is effectively gone. At best, content publishers are able to use “frames’ to keep a shell of their own website around the provider's site, within the guidelines of the agreement with the search provider, but this is only a marginally effective solution. No alternatives have been able to address a fundamental drawback of the affiliate programs—the loss of the visitor to the vendor.

Embodiments of the present disclosure provide a customized search experience for visitors to content publisher's website while ensuring that the search experience appears to be provided by the content publisher itself. This eliminates and overcomes the problems of current solutions.

Embodiments of the present discloser provide a script to the content publisher that they incorporate into their website and associate with a search box. The script provides a search experience that is co-branded with the publisher brand and the search provider brand. Embodiments also provide relevant and fresh content from the publisher domain and also augment with publisher results with search results from the web. In some embodiments, search advertising content is provided to help the publishers monetize their content better than their current models.

The search box with added script provides capabilities such as trending content suggestion on zero input to the search box, and on user keystrokes provide auto-suggestions to help user complete the query. These trending and auto suggest are provided by historical learnings of the search provider from the very first day the content publisher utilizes the provided script. Additionally, over a short period of time, the search provider is able to provide suggestions customized for the publishing website.

In some embodiments, the search results are provided in an overlay page (e.g., iframe). The overlay can comprise one or more of: a combination of articles relevant to the query from the publisher sites, content relevant from web as web links, quick answers, and/or relevant product and/or search ads for the search query.

The co-branding of the search result page utilizes a branding icon or other branding information from the content publisher as well as information indicating the results are provided by the search provider. However, because of the branding using the content publisher, the results page appears to the user as being a part of the content publisher's website and does not draw the user away from the content publisher's website.

The co-branding search experience can also allow content publishers to gain access to features available to the search provider such as various user search query terms and click behaviors from an administrative dashboard, engagement tracking for articles on the publishing website, other web links that are relevant to a user's query, reporting capabilities, and (in some embodiments) advertisements.

These and other aspects are explained more fully below.

### DESCRIPTION

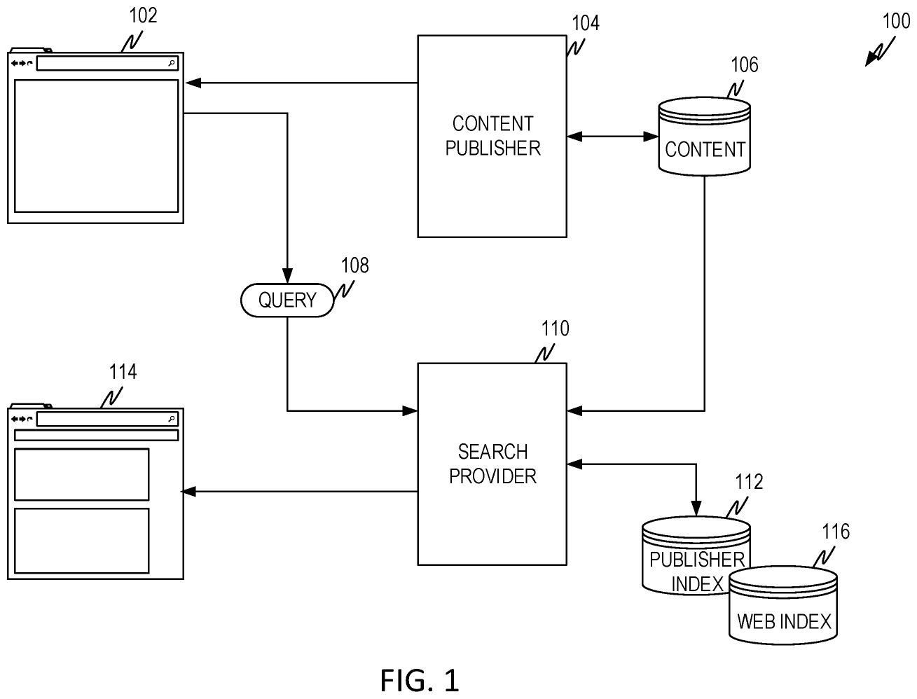

FIG. 1 illustrates an example architecture diagram 100 according to some aspects of the present disclosure. This figure illustrates at a high level the functions performed by a content publisher 104 and a search provider 110.

A content publisher 104 first incorporates a script (not shown) provided by the search provider 110 into a web page having a search box 102. The script performs the functions that “hook up” the text box (e.g., search box) in order to ensure that the information needed for the search provider 110 to provide a cobranded search experience is collected. For example, the script can ensure that appropriate resources are downloaded as part of the web page 102, that a query entered into the search box is appropriately captured, that the search box has appropriate behavior such as query completion, query suggestion, suggestion on zero input (e.g., suggest queries that may be of interest to the user prior to the user starting to enter text into the search box), and so forth.

When the user enters and submits a query 108, the query along with other information as explained herein, is routed to the search provider 110, directly in some embodiments and indirectly through the content publisher 104 in other embodiments.

The search provider, in an offline process, creates a provider index 112 from content 106 published by the content publisher 104. The search provider 110 utilizes the publisher index 112 to identify publisher content relevant to the query 108. Additionally, other information can be retrieved based on the query. For example, web results (e.g., results from the broader web) relevant to the query can be retrieved based on a web index 116.

Branding information that identifies the content publisher 104 is identified. The branding information can be a favicon (i.e., favorite icon) that are typically available from the content publisher or can be information retrieved using an image search such as a logo that is associated with the content publisher, and/or so forth. The branding information is used to create a cobranded search experience.

The branding information, content publisher results, and/or web results are assembled into a results page 114 and returned to the user that submitted the query either directly by the search provider 110, via the content publisher 104, and/or any combination thereof.

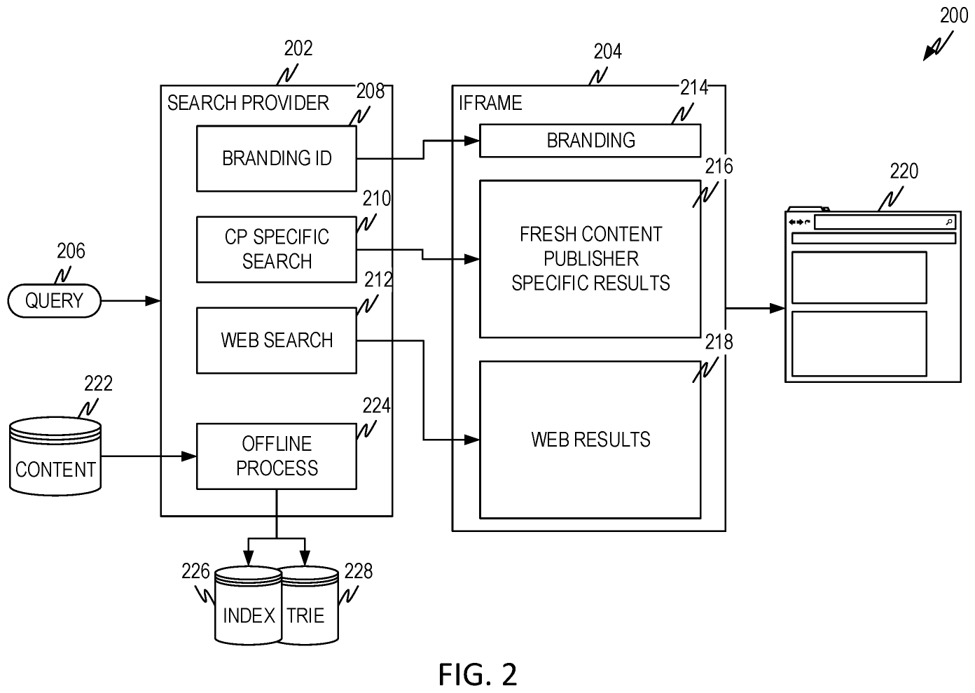

FIG. 2 illustrates a conceptual representation 200 of a cobranded search experience according to some aspects of the present disclosure. As will be apparent from the above high-level description, the cobranded search experience brings together the sophisticated capabilities of the search provider with the content and efforts of the content publisher to produce a search experience that is as rich and functional as the search provider with the branding and “look and feel” of the content publisher so that users are not drawn away from the content publisher's web site but have the user experience provided by the content publisher.

Conceptually, the query 206 and other information identifying the content publisher is processed by the search provider 202 in order to produce several pieces of information that are then placed into an iframe that can be incorporated into a web page that appears to come from the content publisher.

In some embodiments, the information comprises branding information 214. The branding information 214 is identified by the search provider 202 using a process 208 that identifies the branding information associated with the content publisher. As noted herein, in many instances the branding information can be identified using a favicon, or favorite icon. A favicon, also known as a shortcut icon, website icon, tab icon, URL icon, or bookmark icon, is a file containing one or more icons, associated with a particular website or web page. A web designer can create an icon and associate it with a website/web page. Favicons are often used by browsers to display a branding icon in conjunction with a web page tab. The process for locating and retrieving a favicon associated with a website and/or web page is well known and need not be repeated here.

In some situations, a favicon is too small or too low resolution to fully effectuate the branding of the search experience. In these situations, a favicon can be used as an input image into an image search process to identify images/icons of sufficient resolution that can be used for the branding information 214. Search providers have image search capabilities and these capabilities can be employed to locate appropriate branding information.

In some situations, a favicon may be missing or otherwise unavailable. In such situations, the input into an image search can be a text string comprising the name of the content publisher or other content publisher identifying information rather than a favicon.

The results of the image search (either with the favicon as an input, a text string input, and/or both) can be used to identify proper branding information, such as selecting the top image result of appropriate resolution.

In addition to the branding information 214, the search provide 202 produces content publisher specific results 216 using a process 210 that identifies the top results from the content publisher's website. Search provider 202 can identify appropriate results using an index 226 created from content 222 published by the content publisher. In other words, one set of search results 216 comes solely from the content published by the content publisher.

In some embodiments, efforts are made to ensure that the content publisher specific results 216 are “fresh”. In this context “fresh” means content that was recently published and/or that is trending on social media or as reflected in some other trending metric. Recently published means content published no longer than a threshold time ago, such as a week or a month. Trending means content that is popular when a popularity or trending metric exceeds a threshold.

Some search providers have a “news” workflow to identify fresh content rather than wait for a more traditional index update cycle. Such a news workflow can be used to identify content publisher results.

Additionally, in some embodiments additional information is provided by the search provider 202. For example, a search provider can additionally provide one or more of:
Web results which comprises search results that are relevant to the query as determined by the search provider and which come from the web.
Advertisements which comprises advertisements to be served as determined by the search provider.
Segments/Quick Answers which comprises information related to a particular category of information and/or that directly answers the query. For example, a quick answer to the query “how tall was George Washington” would be George Washington's height. A segment can comprise related information in a particular category such as news, sports, business, and so forth.

These additional information 218 can be produced via a process 212 that the search provider 202 uses to produce such information as part of its normal operation.

The information 214, 216, 218 produced by the search provider 202 can be assembled into an iframe 204 that can, in turn, be incorporated into a results page 220 having the cobranding information and/or the look and feel of the website of the content publisher.

In an offline process 224, the search provider 202 utilizes the content publisher's content 222 and/or other information to produce information that allows the search provider to produce the publisher specific results (e.g., index 226). Additionally, as noted herein, the script inserted into the content publisher's web page also provides query related functions such as query completion and/or zero input query suggestions.

Query completion is also referred to as query suggestion. As a user enters a query prefix, the search box drops down a list of suggestions on how the query can be completed. A user can select one of the suggestions to complete the query, if desired. Zero input query suggestions provide relevant query suggestions before a user enters any query prefix into the search box. Thus, as a user activates the search box (clicks on the box, touches the box, and so forth) for data entry, a list of suggestions can be provided even before the user begins to enter a query prefix. Such suggestions can be recently entered queries, trending queries, and so forth as provided by the search provider 202. As the user types each letter of a prefix, the suggestion mechanism updates the list of query suggestions.

Query related functions of embodiments disclosed herein can utilize content publisher specific information such that all the query completions and zero input suggestions are tailored specifically to the content publisher's website. This is illustrated in FIG. 2 by content publisher specific trie 228. Trie 228 represents any information needed for the search provider to provide the query related functions.

When a new content publisher begins using cobranded search services, the search provider 202 may not have sufficient content publisher specific information to build content publisher specific trie 228. Thus, initially, the query related functions can be provided using general information (e.g., a general trie) collected by the search provider. However, as the search provider 202 provides cobranded search services, the search provider 202 will collect information related to queries that will allow the search provider 202 to build the content publisher specific trie 228. Depending on the traffic to the content publisher website and the number of queries submitted, such a content publisher specific trie 228 can generally be produced from data collected over a week or so.

The content publisher specific trie 228 is built using the same methods that the search service 202 uses to build the general trie used to provide query related functions, with the exception that the data used to build the content publisher specific trie 228 is collected from the content publisher websites. In this manner, query completions and/or zero input query suggestions are specific to the content publisher and/or the ways that users interact with the content publisher's content.

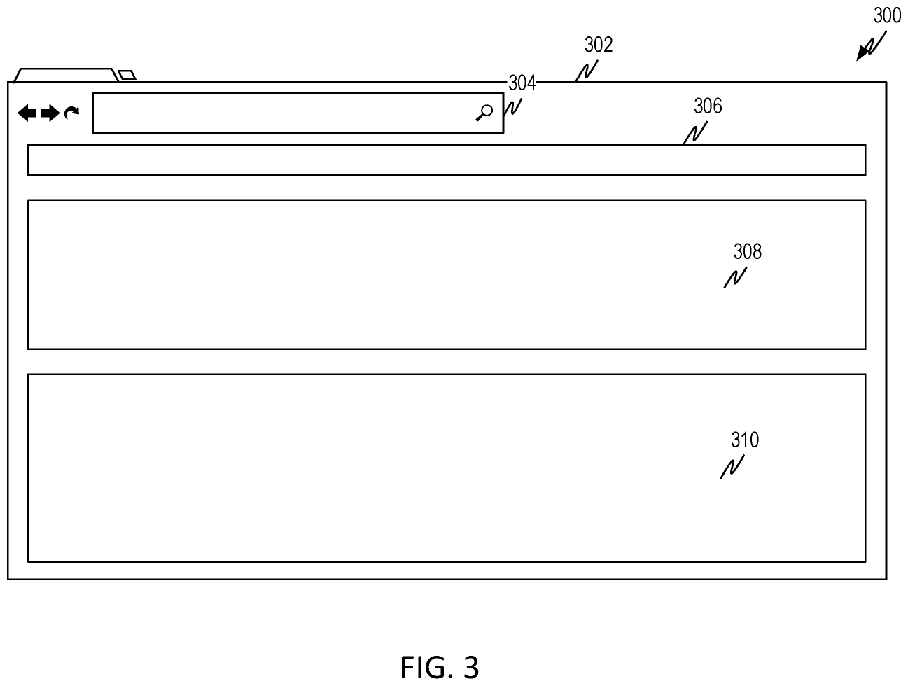

FIG. 3 illustrates an example 300 results page according to some aspects of the present disclosure. The results page 302 can comprise a plurality of areas in which the specific information of the results page can be presented. Not all of the areas need to be incorporated into every results page and some embodiments can produce different results pages.

In some embodiments, the results page 302 can comprise a search box 304 and/or other controls that are common to web pages on the content publisher's website. These can be in the style, color, font, and so forth of the content publisher's website to provide a consistent look and feel between the results page and other pages in the content publisher's website.

As noted above, the results information can be incorporated into an iframe that can be made part of the web page 302. Embodiments of the present disclosure create iframes with one or more of:
Branding information which comprises the branding information of the content publisher and cobranding information of the search provider.
Content publisher specific results which comprises search results from the content publisher's web site.
Web results which comprises search results that are relevant to the query as determined by the search provider and which come from the web.
Advertisements which comprises advertisements to be served as determined by the search provider.
Segments/Quick Answers which comprises information related to a particular category of information and/or that directly answers the query. For example, a quick answer to the query “how tall was George Washington” would be George Washington's height. A segment can comprise related information in a particular category such as news, sports, business, and so forth.

In the results page 302, area 306 can comprise cobranding information. For example, the area 306 can comprise a logo or other information that lets the user know that the search results come from the content publisher's content. Additionally, the branding area 306 can comprise information that lets the user know that the results are provided by the search provider. Thus, the results are cobranded with both the content publisher and search provider.

Area 308 comprises the content publisher specific search results. These are placed in a prominent position in the iframe (and hence in the web page 302) because the user is presumptively more interested in content provided by the content publisher than the remainder of the web given the user entered the query into the content publisher's web site and not into a search page of the search provider.

Area 310 can comprise web results, advertisements, segments, and/or quick answers as provided by the various embodiments and as desired to effectuate the intent of the user, the content publisher, and/or the search provider.

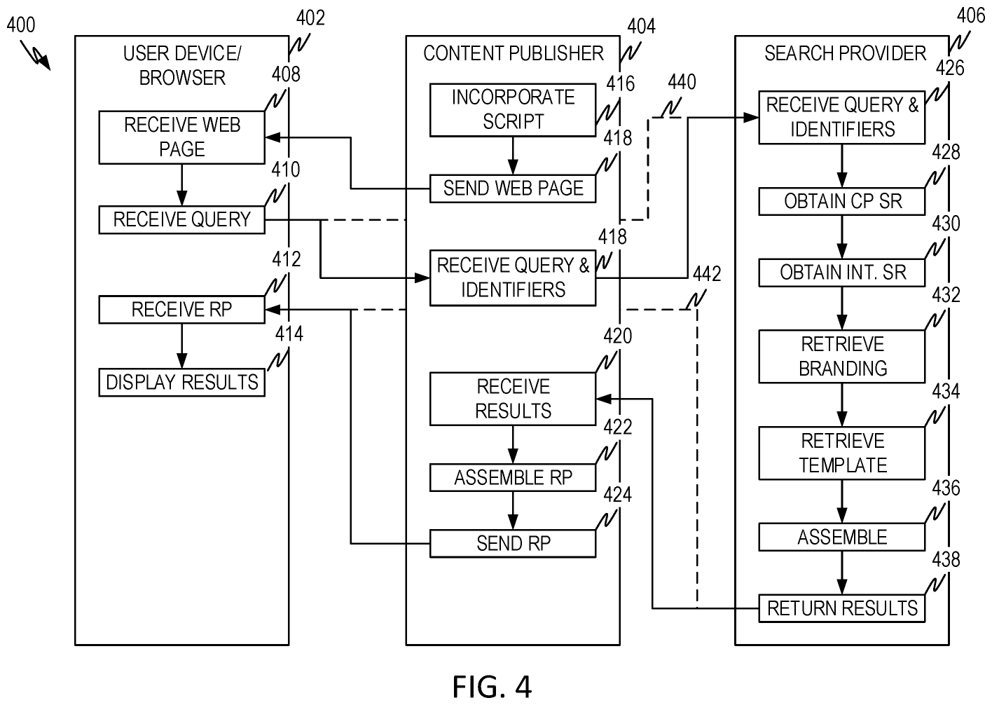

FIG. 4 illustrates an example flow diagram 400 for a cobranded search experience according to some aspects of the present disclosure. The flow diagram shows the interactions between the browser 402 (e.g., on the user device), the content publisher 404, and the search provider 406.

The search provide gives a script to the content publisher 404 and the content publisher 404 incorporates the script into their web page(s) as indicated by operation 416. As discussed herein, the script provides several functions to the web page where it is incorporated, including, but not limited to:
Connecting the textbox (e.g., search box) to the query form so that whatever text box the content provider wishes to use as a query box will function as the query box.
Downloading any resources that are needed for proper functioning of the search functions and query related functions as described herein.
Initializing instrumentation so that appropriate information is captured and provided to the search provider (e.g., so the content publisher specific trie can be built) and/or content publisher.

In operation 416 the content publisher 404 incorporates the script into the desired web page(s). When the web page is requested from the user device 402, such as a request received through the browser, the content publisher 404 sends the requested web page to the user device 402 as shown in operation 418 and operation 408.

In operation 410 the web page receives a query from the user, such as the user typing information into the text/search box of the web page. Alternatively, the user can use voice, gesture, or some other input and that input can be converted to text. The received query is received and sent to the content publisher. The content publisher sends the query, and one or more identifiers to the search provider 406 as shown by operation 418. For example, the content publisher 404 can send a content publisher identifier that identifies the content publisher 404 to the search provider 406. Additionally, or alternatively, the content publisher 404 can send a form code that helps the search provider 406 customize the search experience to the user and/or content publisher 404. For example, the form code can identify which form and/or form variant should be used to create the search results. In this way, the search provider 406 can format the iframe in a manner that the content provider desires. The query and one or more identifiers are received by the search provider 406 as shown in operation 426.

As an alternative to the query being sent to the content publisher 404 which then, in turn, sends the query and one or more identifiers to the search provider 406, the query and one or more identifiers can be sent directly from the user device 402 to the search provider 406 as shown by dashed line 440. In these embodiments, the script can identify the one or more identifiers and send them along with the query to the search provider 406.

After receiving the query and the one or more identifiers (operation 406), the search provider begins to assemble the content for the search results, such as discussed above in conjunction with FIGS. 2 and 3. In operation 428, the content publisher specific search results are determined based on the query and an identifier that identifies the content publisher. For example, the identifier can be used to identify the content publisher 404 and/or a content provider specific index. The search provider 406 can then use the query to identify content specific search results using the content provider specific index.

The search provider 406 can also identify internet search results that are relevant to the query using the query and internet search index, as shown in operation 430.

In operation 432, the search provider 406 retrieves branding information for the content publisher 404. As discussed herein, this can be accomplished by using the favicon, a visual search, and/or both.

In operation 434, the search provider 406 retrieves the template that will be used to provide the search results to the content publisher. In some embodiments, the template can be identified based on a form identifier, a variant derived from the form identifier, and/or in some other way. In the context, a variant is a variant of the template to be used to return search results.

Operation 436 assembles the information into the template. In some embodiments the template is an iframe template that can be incorporated into a web page such as a results page. In other embodiments, the template can be a web page template, such a search results page template.

In some embodiments additional information is placed into the template. For example, advertisements can be placed in the template along with content publisher specific search results, internet search results, and/or branding information. In other embodiments, segments and/or quick answers which comprises information related to a particular category of information and/or that directly answers the query can be included.

Operation 438 returns the results to the content publisher 404 and/or directly to the user device 402 (dashed line 442). In one example, an iframe containing the content publisher search results, internet search results, branding information, and/or other information is returned to the content publisher 404. Operation 420 shows receipt of the iframe.

Operation 422 assembles the results page such as by placing the iframe with the results and branding information into a results page template.

Operation 424 sends the results page to the user device 402 which receives the results page (operation 412) and displays the results page to the user (operation 414).

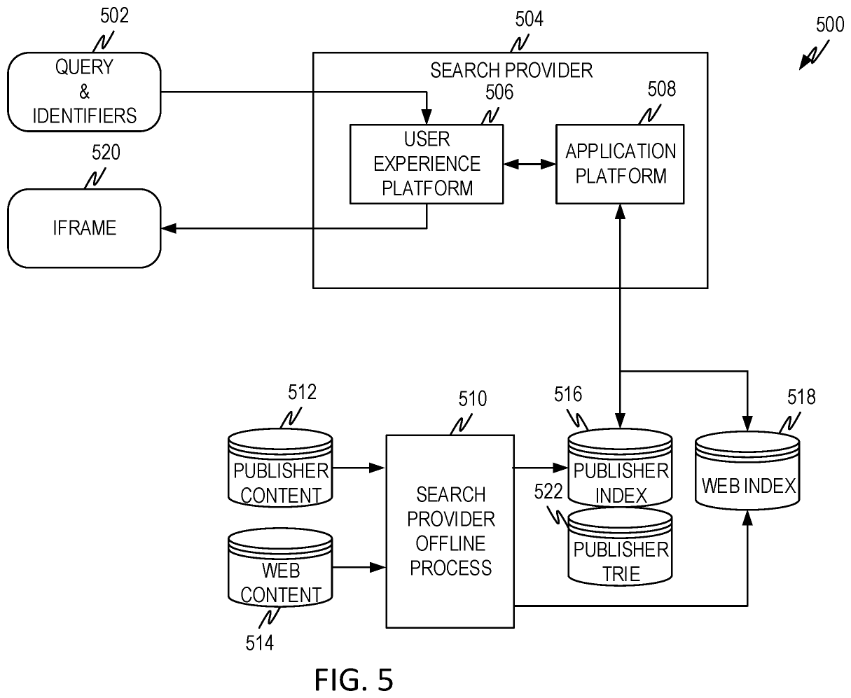

FIG. 5 illustrates an example architecture 500 for a cobranded search experience according to some aspects of the present disclosure. The architecture 500 shows an example of how the search provider in both online processes 504 and offline processes 510 may be implemented in some embodiments.

The search provider offline processes 510 use web content 514 to build one or more web indexes 518 using processes that are known in the industry. Thus, the search provider offline processes 510 can crawl web content 514 to discover new and/or changed information that should be added to the web indexes 518 as is usually done by search providers.

In addition, a content publisher's content can be used to create a publisher index 516 which allows search results for a publisher's content to be determined in conjunction with a received query. The content publisher index 516 can be created using the same process that is used to create the web index 518. However, in some instances, where a content publisher publishes new content hourly or, in some cases, within minutes, the standard process may not lend itself to discovering and indexing fresh content, as defined herein. Thus, to catch fresh content and make it available as soon as possible, some embodiments of the present disclosure utilize a workflow suitable for news or other short-cycle content. These processes are known and utilized by some search providers so that even content that is only a few minutes old can be discovered and made available.

Additionally, as users interact with the content publisher's website through queries and other interactions, a content publisher trie 522 can be created from these interactions. As discussed above, the content publisher trie 522 is used in some embodiments to provide query completion suggestions and/or zero input query suggestions that are customized to the content publisher's website and content.

A user enters a query and the query and/or other identifiers such as the content publisher identifier 502 are passed to the search provider real-time processes 504. How the search provider processes and retrieves the content for the query can vary somewhat from embodiment to embodiment. In a representative example, processing the received query and/or identifiers are broken down between at least two major processes. The first of these is the user experience platform 506 and the second of these is the application platform 508.

The user experience platform 506 performs one or more the following in any combination:
identifying and passing the correct advertisement unit identifier, if advertisements are to be identified and returned in the results. Advertisement unit identifiers help the system select appropriate advertisements.
identifying and passing the correct product identifier. Product identifiers identify what service is to be provided when multiple various services can be provided by the application platform. In the present situation, the product identifier would be for cobranded search.
determine and create a publisher variant based on a form code. A form code can identify which form should be used to provide search results to the user. A variant is a variation of the form.
passing the publisher identifier.
passing the correct domain/website that should be used to identify publisher specific search results.
fetching and passing the favicon or other branding information.

The application platform 508 receives the information passed to it by the user experience platform 506. The application platform then performs one or more of the following in any combination:
consume the variant and suppress any quick answers/segments on an associated blacklist.
invoke a workflow such as a news workflow in order to obtain fresh content for the publisher specific search results.
invoke a workflow to retrieve web results.
retrieve advertisements and/or other information that will be included on the results page.
rank and select content publisher results, web results, and/or other information.
assemble the results and other information into the proper iframe and/or web page as appropriate.

Once the iframe is assembled, the iframe 520 is returned to the user and/or content publisher as described herein.

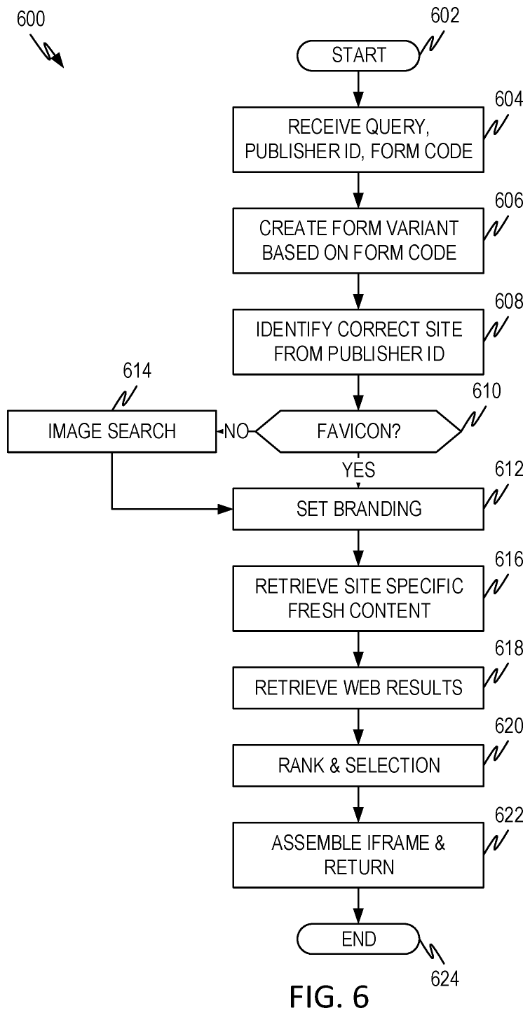

FIG. 6 illustrates an example flow diagram 600 according to some aspects of the present disclosure. The process begins at operation 602 and proceeds to operation 604 where the query and/or other identifiers are received by the search provider.

Operation 606 creates the form variant based on the form code as described above.

Operation 608 identifies the correct websites/domains that will be used to create the content provider specific results such as by using the publisher identifier.

Operation 610 identifies whether a favicon exists and whether it is suitable for use in cobranding, for example by identifying whether the favicon has sufficient resolution. If the favicon exists and is suitable, execution proceeds to operation 612 where the favicon is used to set the cobranding information.

If the favicon does not exist or is not suitable, operation 614 performs an image search as previously explained to identify appropriate branding information. The branding information is then used in operation 612 to set the cobranding information.

Operation 616 retrieves content publisher specific search results relevant to the retrieved query. As explained herein, a workflow that retrieves fresh results is used in some embodiments.

Operation 618 retrieves web results that are relevant to the query. The web results are those that are identified using the web indexes and can also comprise segments and/or quick answers that are not suppressed as described herein.

Operation 620 performs a ranking and selection of the results that are to be returned. Ranking and selection can occur using the processes normally utilized by the search provider.

Operation 622 assembles the iframe and returns the assembled iframe as described herein.

### Example Machine Architecture and Machine-Readable Medium

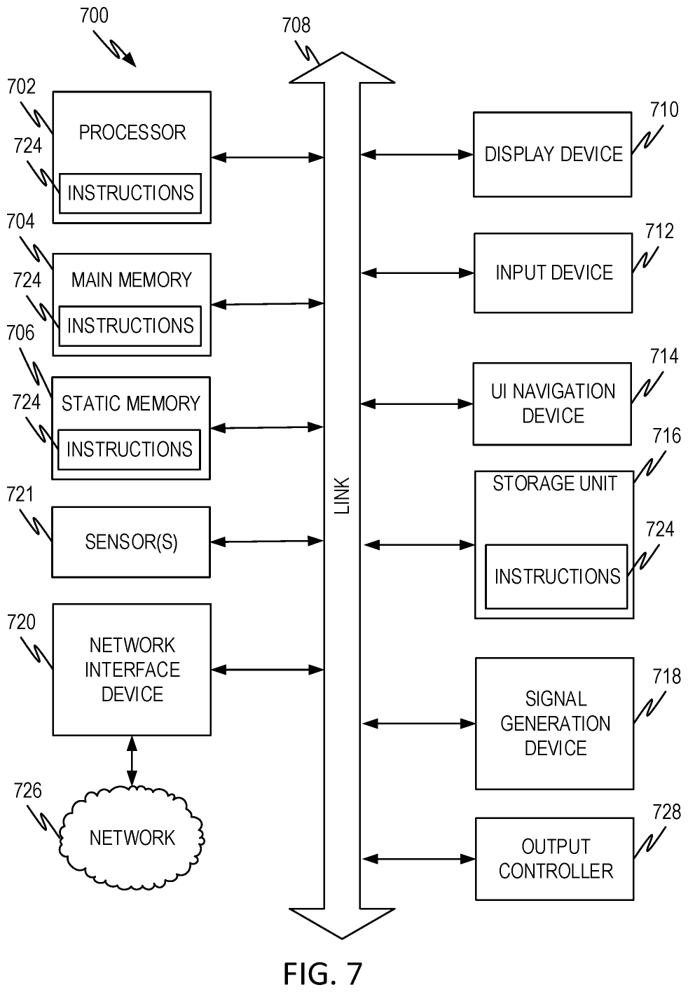

FIG. 7 illustrates a representative machine architecture suitable for implementing the systems and so forth or for executing the methods disclosed herein. The machine of FIG. 7 is shown as a standalone device, which is suitable for implementation of the concepts above. For the server aspects described above a plurality of such machines operating in a data center, part of a cloud architecture, and so forth can be used. In server aspects, not all of the illustrated functions and devices are utilized. For example, while a system, device, etc. that a user uses to interact with a server and/or the cloud architectures may have a screen, a touch screen input, etc., servers often do not have screens, touch screens, cameras and so forth and typically interact with users through connected systems that have appropriate input and output aspects. Therefore, the architecture below should be taken as encompassing multiple types of devices and machines and various aspects may or may not exist in any particular device or machine depending on its form factor and purpose (for example, servers rarely have cameras, while wearables rarely comprise magnetic disks). However, the example explanation of FIG. 7 is suitable to allow those of skill in the art to determine how to implement the embodiments previously described with an appropriate combination of hardware and software, with appropriate modification to the illustrated embodiment to the particular device, machine, etc. used.

While only a single machine is illustrated, the term “machine” shall also be taken to include any collection of machines that individually or jointly execute a set (or multiple sets) of instructions to perform any one or more of the methodologies discussed herein.

The example of the machine 700 includes at least one processor 702 (e.g., a central processing unit (CPU), a graphics processing unit (GPU), advanced processing unit (APU), or combinations thereof), one or more memories such as a main memory 704, a static memory 706, or other types of memory, which communicate with each other via link 708. Link 708 may be a bus or other type of connection channel. The machine 700 may include further optional aspects such as a graphics display unit 710 comprising any type of display. The machine 700 may also include other optional aspects such as an alphanumeric input device 712 (e.g., a keyboard, touch screen, and so forth), a user interface (UI) navigation device 714 (e.g., a mouse, trackball, touch device, and so forth), a storage unit 716 (e.g., disk drive or other storage device(s)), a signal generation device 718 (e.g., a speaker), sensor(s) 721 (e.g., global positioning sensor, accelerometer(s), microphone(s), camera(s), and so forth), output controller 728 (e.g., wired or wireless connection to connect and/or communicate with one or more other devices such as a universal serial bus (USB), near field communication (NFC), infrared (IR), serial/parallel bus, etc.), and a network interface device 720 (e.g., wired and/or wireless) to connect to and/or communicate over one or more networks 726.

### Executable Instructions and Machine-Storage Medium

The various memories (i.e., 704, 706, and/or memory of the processor(s) 702) and/or storage unit 716 may store one or more sets of instructions and data structures (e.g., software) 724 embodying or utilized by any one or more of the methodologies or functions described herein. These instructions, when executed by processor(s) 702 cause various operations to implement the disclosed embodiments.

As used herein, the terms “machine-storage medium,” “device-storage medium,” “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include storage devices such as solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms machine-storage media, computer-storage media, and device-storage media specifically and unequivocally excludes carrier waves, modulated data signals, and other such transitory media, at least some of which are covered under the term “signal medium” discussed below.

### Signal Medium

The term “signal medium” shall be taken to include any form of modulated data signal, carrier wave, and so forth. The term “modulated data signal” means a signal that has one or more of its characteristics set or changed in such a matter as to encode information in the signal.

### Computer Readable Medium

The terms “machine-readable medium,” “computer-readable medium” and “device-readable medium” mean the same thing and may be used interchangeably in this disclosure. The terms are defined to include both machine-storage media and signal media. Thus, the terms include both storage devices/media and carrier waves/modulated data signals.

### EXAMPLE EMBODIMENTS

Example 1. A method implemented by a search system, comprising:

receiving a query and an identifier identifying a content publisher;

determining, based on the identifier, at least one publisher search index created from content published by the content publisher;

obtaining a first set of search results based on the at least one publisher search index;

determining branding information based on the identifier;

obtaining a second set of search results based on at least one web search index;

assembling an iframe comprising:

the branding information;

the first set of search results; and

the second set of search results; and

returning the iframe.

Example 2. The method of claim 1 further comprising suppressing quick answers in a blacklist.

Example 3. The method of claim 1 or 2 wherein obtaining a first set of search results comprises invoking a news workflow to retrieve recently published content from the content publisher.

Example 4. The method of claim 1, 2, or 3 further comprising sending a script to the content publisher such that the script can be incorporated into the content publisher's website.

Example 5. The method of claim 4 wherein the script performs the method:

connecting a textbox to a query form;

downloading resources for the query form; and

initializes instrumentation.

Example 6. The method of claim 1, 2, 3, 4, or 5 wherein determining branding information based on the identifier comprises:

identify the content publisher based on the identifier;

determining whether a favicon for the content publisher is available;

responsive to determining that the favicon is available, using the favicon as part of the branding information.

Example 7. The method of claim 6 further comprising:

responsive to determining that the favicon is not available, performing an image search to retrieve an image associated with the content publisher and using the image as part of the branding information.

Example 8. The method of claim 1, 2, 3, 4, 5, 6, or 7 wherein obtaining a first set of search results comprises:

retrieving a candidate set of results based on the based on the at least one publisher search index;

ranking the candidate set of results according to a published time or a metric to indicate trending of a result;

selecting a subset of the candidate set of results as the first set of search results based upon the ranking.

Example 9. The method of claim 1, 3, 4, 5, 6, 7, or 8 further comprising:

selecting a blacklist based upon the identity of the content publisher;

suppressing quick answers in a blacklist; and

wherein the second set of search results comprises quick answers not suppressed by the blacklist.

Example 10. The method of claim 1, 2, 3, 4, 5, 6, 7, 8, or 9 further comprising:

selecting an advertising identifier based on the identity of the content publisher;

selecting a set of advertisements; and

adding the selected set of advertisements to the iframe.

Example 11. The method of claim 1, 2, 3, 4, 5, 8, 9, or 10 wherein determining branding information based on the identifier comprises:

identify the content publisher based on the identifier;

determining whether a favicon for the content publisher is available;

responsive to determining that the favicon is available, determining whether the favicon is suitable for branding based on the resolution of the favicon.

Example 12. The method of claim 11 further comprising:

responsive to determining that the favicon is suitable for branding, using the favicon as part of the branding information.

Example 13. The method of claim 12 further comprising:

responsive to determining that the favicon is not suitable for branding, performing an image search to retrieve an image associated with the content publisher and using the image as part of the branding information.

Example 14. An apparatus comprising means to perform a method as in any preceding claim.

Example 15. Machine-readable storage including machine-readable instructions, when executed, to implement a method or realize an apparatus as in any preceding claim.

Example 16. A method implemented by a search system, comprising:

receiving a query and an identifier identifying a content publisher;

determining, based on the identifier, at least one publisher search index created from content published by the content publisher;

obtaining a first set of search results based on the at least one publisher search index;

determining branding information based on the identifier;

obtaining a second set of search results based on at least one web search index;

assembling an iframe comprising:

the branding information;

the first set of search results; and

the second set of search results; and

returning the iframe.

Example 17. The method of claim 16 further comprising suppressing quick answers in a blacklist.

Example 18. The method of claim 16 wherein obtaining a first set of search results comprises invoking a news workflow to retrieve recently published content from the content publisher.

Example 19. The method of claim 16 further comprising sending a script to the content publisher such that the script can be incorporated into the content publisher's web site.

Example 20. The method of claim 19 wherein the script performs the method:

connecting a textbox to a query form;

downloading resources for the query form; and

initializes instrumentation.

Example 21. The method of claim 16 wherein determining branding information based on the identifier comprises:

identify the content publisher based on the identifier;

determining whether a favicon for the content publisher is available;

responsive to determining that the favicon is available, using the favicon as part of the branding information.

Example 22. The method of claim 21 further comprising:

responsive to determining that the favicon is not available, performing an image search to retrieve an image associated with the content publisher and using the image as part of the branding information.

Example 23. The method of claim 16 wherein obtaining a first set of search results comprises:

retrieving a candidate set of results based on the based on the at least one publisher search index;

ranking the candidate set of results according to a published time or a metric to indicate trending of a result;

selecting a subset of the candidate set of results as the first set of search results based upon the ranking.

Example 24. The method of claim 16 further comprising:

selecting a blacklist based upon the identity of the content publisher;

suppressing quick answers in a blacklist; and

wherein the second set of search results comprises quick answers not suppressed by the blacklist.

Example 25. The method of claim 16 further comprising:

selecting an advertising identifier based on the identity of the content publisher;

selecting a set of advertisements; and

adding the selected set of advertisements to the iframe.

Example 26. A system comprising a processor and computer executable instructions, that when executed by the processor, cause the system to perform operations comprising:

receiving a query and an identifier identifying a content publisher;

determining, based on the identifier, at least one publisher search index created from content published by the content publisher;

obtaining a first set of search results based on the at least one publisher search index;

determining branding information based on the identifier;

obtaining a second set of search results based on at least one web search index;

assembling an iframe comprising:

the branding information;

the first set of search results; and

the second set of search results; and

returning the iframe.

Example 27. The system of claim 26 further comprising suppressing quick answers in a blacklist.

Example 28. The system of claim 26 wherein obtaining a first set of search results comprises invoking a news workflow to retrieve recently published content from the content publisher.

Example 29. The system of claim 26 further comprising sending a script to the content publisher such that the script can be incorporated into the content publisher's web site.

Example 30. The system of claim 29 wherein the script performs the method:

connecting a textbox to a query form;

downloading resources for the query form; and

initializes instrumentation.

### CONCLUSION

In view of the many possible embodiments to which the principles of the present invention and the forgoing examples may be applied, it should be recognized that the examples described herein are meant to be illustrative only and should not be taken as limiting the scope of the present invention. Therefore, the invention as described herein contemplates all such embodiments as may come within the scope of the following claims and any equivalents thereto.

What is claimed is:

1. A method implemented by a search system, comprising:
receiving a query and an identifier identifying a content publisher;
determining, based on the identifier, at least one publisher search index created from content published by the content publisher;
obtaining a first set of search results based on the at least one publisher search index;
determining branding information based on the identifier;
obtaining a second set of search results based on at least one web search index;
assembling an iframe comprising:
the branding information;
the first set of search results; and
the second set of search results; and
returning the iframe.

2. The method of claim 1 further comprising suppressing quick answers in a blacklist.

3. The method of claim 1 wherein obtaining a first set of search results comprises invoking a news workflow to retrieve recently published content from the content publisher.

4. The method of claim 1 further comprising sending a script to the content publisher such that the script can be incorporated into the content publisher's website.

5. The method of claim 4 wherein the script performs the method:
connecting a textbox to a query form;
downloading resources for the query form; and
initializes instrumentation.

6. The method of claim 1 wherein determining branding information based on the identifier comprises:
identify the content publisher based on the identifier;
determining whether a favicon for the content publisher is available;
responsive to determining that the favicon is available, using the favicon as part of the branding information.

7. The method of claim 6 further comprising:
responsive to determining that the favicon is not available, performing an image search to retrieve an image associated with the content publisher and using the image as part of the branding information.

8. The method of claim 1 wherein obtaining a first set of search results comprises:
retrieving a candidate set of results based on the based on the at least one publisher search index;
ranking the candidate set of results according to a published time or a metric to indicate trending of a result;
selecting a subset of the candidate set of results as the first set of search results based upon the ranking.

9. The method of claim 1 further comprising:
selecting a blacklist based upon the identity of the content publisher;
suppressing quick answers in a blacklist; and
wherein the second set of search results comprises quick answers not suppressed by the blacklist.

10. The method of claim 1 further comprising:
selecting an advertising identifier based on the identity of the content publisher;
selecting a set of advertisements; and
adding the selected set of advertisements to the iframe.

11. A system comprising a processor and computer executable instructions, that when executed by the processor, cause the system to perform operations comprising:
receiving a query and an identifier identifying a content publisher;
determining, based on the identifier, at least one publisher search index created from content published by the content publisher;
obtaining a first set of search results based on the at least one publisher search index;
determining branding information based on the identifier;
obtaining a second set of search results based on at least one web search index;
assembling an iframe comprising:
the branding information;
the first set of search results; and
the second set of search results; and
returning the iframe.

12. The system of claim 11 further comprising suppressing quick answers in a blacklist.

13. The system of claim 11 wherein obtaining a first set of search results comprises invoking a news workflow to retrieve recently published content from the content publisher.

14. The system of claim 11 further comprising sending a script to the content publisher such that the script can be incorporated into the content publisher's website.

15. The system of claim 14 wherein the script performs the method:
connecting a textbox to a query form;
downloading resources for the query form; and
initializes instrumentation.

16. The system of claim 11 wherein determining branding information based on the identifier comprises:
identify the content publisher based on the identifier;
determining whether a favicon for the content publisher is available;
responsive to determining that the favicon is available, using the favicon as part of the branding information.

17. The system of claim 16 further comprising:
responsive to determining that the favicon is not available, performing an image search to retrieve an image associated with the content publisher and using the image as part of the branding information.

18. The system of claim 11 wherein obtaining a first set of search results comprises:
retrieving a candidate set of results based on the based on the at least one publisher search index;
ranking the candidate set of results according to a published time or a metric to indicate trending of a result;
selecting a subset of the candidate set of results as the first set of search results based upon the ranking.

19. A computer storage medium comprising executable instructions that, when executed by a processor of a machine, cause the machine to perform operations comprising:
receiving a query and an identifier identifying a content publisher;
determining, based on the identifier, at least one publisher search index created from content published by the content publisher;
obtaining a first set of search results based on the at least one publisher search index;
determining branding information based on the identifier;
obtaining a second set of search results based on at least one web search index;
assembling an iframe comprising:
the branding information;
the first set of search results; and
the second set of search results; and
returning the iframe.

20. The computer storage medium of claim 19 wherein the query and the identifier is received from the content publisher.
